(19) United States
(12) Patent Application Publication
(10) Pub. No.: US 2010/0082965 A1
(43) Pub. Date: Apr. 1, 2010

(54) INFORMATION PROCESSING APPARATUS AND METHOD OF CONTROLLING INFORMATION PROCESSING APPARATUS

(75) Inventors: Tadashi Tsuji, Tachikawa-shi (JP); Toru Hanada, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/474,167

(22) Filed: May 28, 2009

(30) Foreign Application Priority Data
Sep. 30, 2008 (JP) 2008-255619

(51) Int. Cl. G06F 9/00

(52) U.S. Cl. 713/2

(57) ABSTRACT

According to an aspect of the present invention, there is provided an information processing apparatus configured to be operated by an operating system, including: a display device; a BIOS-ROM configured to store a BIOS program to be executed before starting the operating system; a memory configured to store image data to be displayed on the display device before starting the operating system during an execution of the BIOS program; a processor configured to execute a compression determination program configured to determine whether the image data are stored in the memory in a compression state or in a non-compression state and an expansion program configured to expand the image data stored in the compression state through an execution of the determination program; and a display controller configured to display, on the display device, the expanded image data.

### CROSS-REFERENCE TO RELATED APPLICATIONS

This application is based upon and claims the benefit of priority from Japanese Patent Application No. 2008-255619, filed on Sep. 30, 2008, the entire contents of which are incorporated herein by reference.

### BACKGROUND

1. Field

An aspect of the present invention relates to an information processing apparatus and a method of causing an image displayed on a display device before an operation of an operating system to have a higher resolution.

2. Description of the Related Art

In an information processing apparatus such as a personal computer of a notebook type, generally, the computer is managed by software referred to as an operating system which offers a basic function to be required in common to each application software. Usually, the computer is turned ON and a program referred to as a BIOS is then started, and an operating system stored in a hard disc is read into a memory so that a user operable state is brought. In some cases, names of a manufacturer and a product of the computer are displayed on a starting screen through the BIOS while the BIOS is started to be operated and the operating system is then actuated.

JP-A-2005-6185 discloses an image reproducing apparatus which has an object to reproduce, as a starting screen, image data recorded by utilizing a part of a hard disc drive, thereby eliminating the necessity for including a special peripheral circuit and enhancing an expressing capability without increasing a cost for the starting screen under the same control as a reproducing function.

In a computer, usually, a logo image to be displayed in a starting operation of a BIOS is stored in a bit map format. Referring to the image in the bit map format, an image capacity is increased in proportion to a resolution. For this reason, there is a hindrance in an increase in a resolution of a logo image stored in a nonvolatile storage apparatus having a limited storage capacity or a display of an image having a high resolution such as a photograph in place of the logo image. There has been desired a mechanism capable of increasing the resolution of the logo image to be stored in the nonvolatile storage apparatus having the limitation of the storage capacity.

### SUMMARY

It is one of objects of the invention to provide an information processing apparatus capable of causing an image displayed on a display device before an operation of an operating system to have a higher resolution.

According to an aspect of the present invention, there is provided an information processing apparatus configured to be operated by an operating system, including: a display device; a BIOS-ROM configured to store a BIOS program to be executed before starting the operating system; a memory configured to store image data to be displayed on the display device before starting the operating system during an execution of the BIOS program; a processor configured to execute a compression determination program configured to determine whether the image data are stored in the memory in a compression state or in a non-compression state and an expansion program configured to expand the image data stored in the compression state through an execution of the determination program; and a display controller configured to display, on the display device, the image data expanded through the execution of the expansion program.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary perspective view showing an outer appearance of a computer according to an embodiment of the invention;

FIG. 2 is an exemplary block diagram showing a configuration of the computer according to the embodiment of the invention;

FIG. 3 is a diagram showing an example of a BIOS-ROM configuration according to the embodiment of the invention;

FIG. 4 is a diagram showing an example of a logo image data configuration according to the embodiment of the invention;

FIG. 5 is an exemplary flowchart showing a logo image display processing according to the embodiment of the invention; and

FIG. 6 is a view showing an example of a logo image according to the embodiment of the invention.

### DETAILED DESCRIPTION

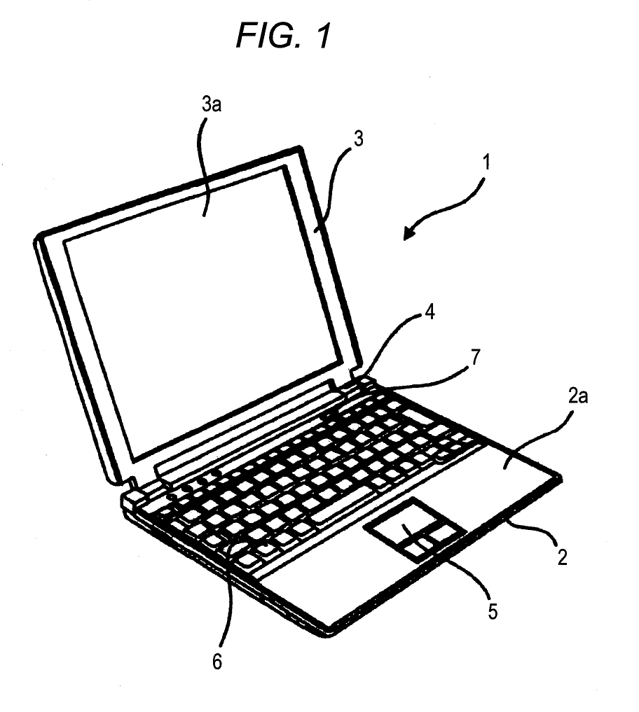

An embodiment according to the invention will be described below with reference to the drawings. In the embodiment, the description will be given by taking a computer of a notebook type as an example of an information processing apparatus. FIG. 1 is a perspective view showing an outer appearance of the computer according to the embodiment of the invention.

A computer 1 includes a body casing 2 and a display casing 3 is rotatably attached to the body casing 2 through a hinge portion 4. The display casing 3 is rotatable between an opening position in which an upper face 2a of the body casing 2 is opened and a closing position in which the upper face 2a of the casing 2 is covered. A display device 3a configured by a Liquid Crystal Display (LCD) is incorporated into the display casing 3.

A circuit board (not shown) provided with a plurality of electronic components is accommodated in the body casing 2. A touch pad 5 and a keyboard 6 which serve to carry out an input operation through a user are attached to the upper face 2a of the body casing 2. The upper face 2a of the body casing 2 is also provided with a power switch 7 for turning ON/OFF a power supply of the computer 1.

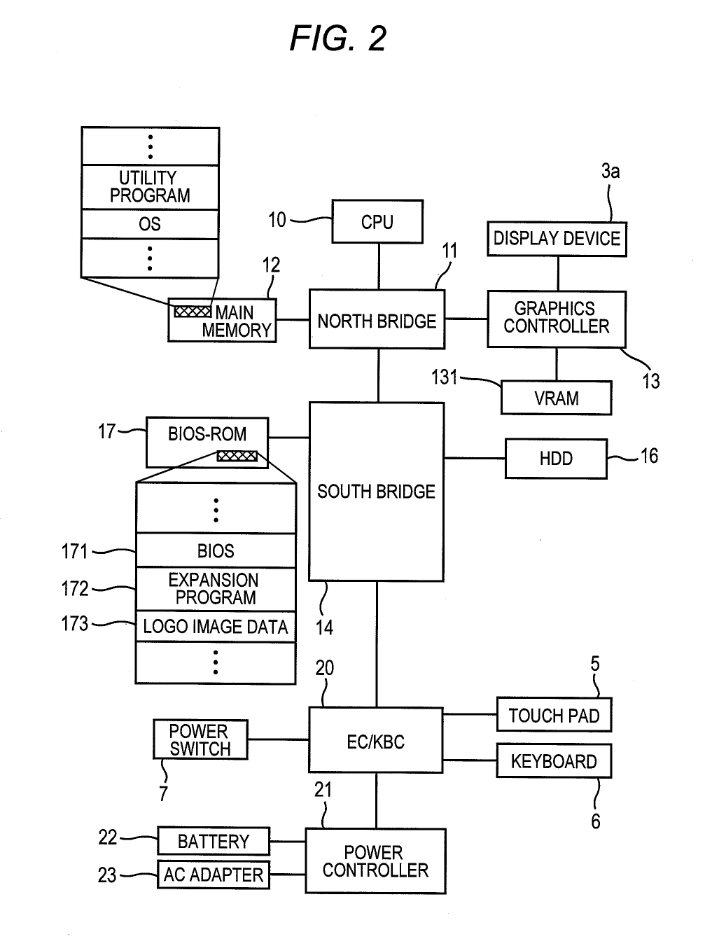

FIG. 2 is a block diagram showing a configuration of the computer according to the embodiment of the invention. The computer 1 is provided with a CPU 10, a north bridge 11, a main memory (RAM) 12, a graphics controller 13, a south bridge 14, a hard disc drive (HDD) 16, a BIOS-ROM 17, an embedded controller/keyboard controller IC (EC/KBC) 20, the display device 3a, the touch pad 5, the keyboard 6, and the power switch 7.

The CPU 10 is a processor for controlling an operation of each component in the computer 1. The CPU 10 executes an operating system to be loaded from the HDD 16 onto the main memory (RAM) 12 and various application programs/utility programs. The main memory (RAM) 12 is also used for a storage of various data buffers.

Moreover, the CPU 10 also executes a Basic Input Output System (BIOS) 171 stored in the BIOS-ROM 17. The BIOS 171 is a program for a hardware control. The BIOS 171 includes a BIOS driver group and each BIOS driver includes a plurality of function executing routine groups corresponding to a plurality of functions for the hardware control in order to offer the same functions to an operating system or an application program.

Furthermore, the BIOS 17 also executes a processing for expanding the operating system from a storage device such as the HDD 16 into the main memory (RAM) 12 and bringing the computer 1 into a user operable state.

In addition, an expansion program 172 and logo image data 173 are also stored in the BIOS-ROM 17; The expansion program 172 and the logo image data 173 will be described below in detail.

The north bridge 11 is a bridge device for connecting a local bus of the CPU 10 to the south bridge 14. Moreover, the north bridge 11 also has a function for executing a communication with the graphics controller 13 through a PCI Express bus. Furthermore, the north bridge 11 also includes a memory controller for controlling the main memory (RAM) 12.

The graphics controller 13 is a display controller for controlling the display device 3a to be used as a display monitor of the computer 1. The graphics controller 13 sends, to the display device 3a, a video signal corresponding to display data written to a video memory (VRAM) 131 in accordance with an OS or an application program.

The south bridge 14 is connected to a Peripheral Component Interconnect (PCI) bus and a Low Pin Count (LPC) bus respectively, and controls a PCI device or an LPC device. The Hard Disc Drive (HDD) 16 stores the OS and various application programs/utility programs and data files.

The embedded controller/keyboard controller (EC/KBC) 20 is a one-chip microcomputer in which an embedded controller for a power management and a keyboard controller for controlling the touch pad 5 and the keyboard 6 are integrated. The EC/KBC 20 executes a processing for turning ON/OFF the computer 1 in response to an operation of the power switch 7 through a user in cooperation with a power controller 21. The power controller 21 supplies a power to each component in the computer 1 by using a power supplied from a battery 22 provided in the computer 1 or a power supplied from an outside through an AC adapter 23.

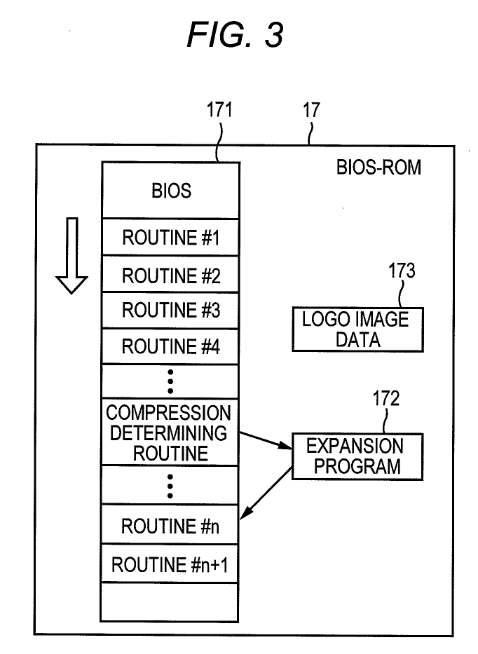

FIG. 3 is a diagram showing an example of a BIOS-ROM configuration according to an embodiment of the invention. The BIOS-ROM 17 stores the BIOS 171, the expansion program 172 and the logo image data 173. The BIOS 171 executes a processing for reading an operating system into the main memory (RAM) 12 to carry out starting in response to a power ON operation of the computer 1 and a processing for bringing the computer 1 into a user operable state, for example, a processing for initializing each hardware.

When the power ON operation of the computer 1 is carried out, the BIOS 171 executes processing routines #1, #2, . . . #n required for bringing the computer 1 into a usable state in series or in parallel.

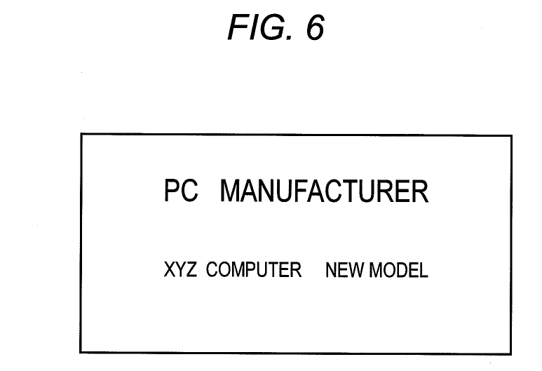

The processings to be executed by the BIOS 171 also include a processing for displaying logo images representing a manufacturer name (PC MANUFACTURER) and a product name (XYZ Computer New Model) for the computer 1 shown in FIG. 6 before the starting operation of the operating system. The images to be displayed at this time are stored as the logo image data 173 in a region in the BIOS-ROM 17.

The BIOS 171 includes a compression determining routine and carries out a processing for determining whether the logo image data 173 is stored in a compression state or in a non-compression state through the same routine. When the logo image data 173 is compressed, the expansion program 172 included in the BIOS-ROM 17 carries out a processing for expanding the logo image data 173.

The expansion program 172 may be provided separately from the BIOS 171 in a format of a binary code which can be directly read by the computer 1 to cause the BIOS 171 to give access to and execute the expansion program 172 during the starting processing of the computer 1 or may be incorporated into the BIOS 171 from the beginning.

When the expansion program 172 is executed to expand the logo image data 173, routines #n, #n+1 . . . for starting the computer 1 are successively executed. The routines #n, #n+1 . . . may be carried out after the execution of the expansion program 172 is completed or, as a matter of course, may be carried out simultaneously with the execution of the expansion program 172.

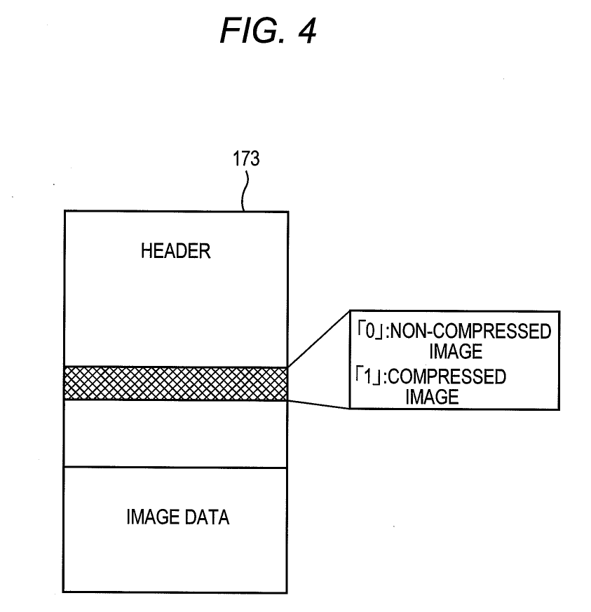

FIG. 4 is a diagram showing an example of a logo image data configuration according to the embodiment of the invention.

The logo image data 173 stored in the BIOS-ROM 17 have image data to be an image and a header including an image size, a file name, an update date and a compressing format in addition to an image data body. A flag is also provided in the header. The flag serves to indicate whether the logo image data 173 are stored in the compression state or in the non-compression state. In the embodiment, it is assumed that the flag of “0” indicates that the logo image data 173 are stored in the non-compression state and the flag of “1” indicates that the logo image data 173 are stored in the compression state.

In the embodiment, for example, it is defined that data compressed by a reversible compressing method in which uncompressed data and data subjected to a compression and expansion processing are equal to each other as in a run length compression are also stored in the non-compression state in addition to data which are not subjected to the compression processing. It is defined that the compressed data are stored in the compression state through an irreversible compressing method.

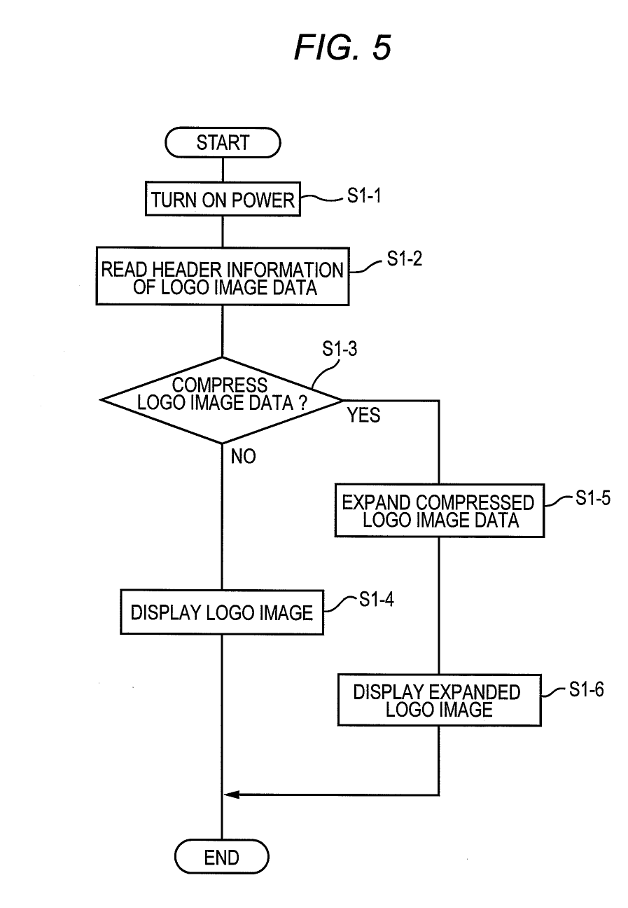

FIG. 5 is a flowchart showing a logo image display processing according to the embodiment of the invention. The power switch 7 is pressed down by the user so that the computer 1 is turned ON (Step S1-1). The computer 1 is turned ON so that the BIOS 171 executes various processings for enabling the computer 1 to be used, and at the same time, also carries out a processing for reading header information of the logo image data 173 stored in the BIOS-ROM 17 (Step S1-2). The BIOS 171 reads the header information of the logo image data 173, thereby determining whether the logo image data 173 are stored in the compression state or the non-compression state (Step S1-3). If the logo image data 173 are stored in the non-compression state (No in Step S1-3), the read logo image data 173 are displayed on the display device 3a (Step S1-4). When the logo image data 173 are to be displayed, the BIOS 171 once copies the logo image data 173 onto the main memory 12 and converts the logo image data 173 copied onto the main memory 12 into a suitable format for the video memory 131, and writes the data thus obtained to the video memory 131. Then, the graphics controller 13 sends, to the display device 3a, a video signal corresponding to the data written to the video memory 131, thereby displaying, on a screen of the display device 3a, a logo image in a format which can be visually recognized by the user as shown in FIG. 6.

On the other hand, if the logo image data 173 are stored in the compression state (Yes in Step S1-3), the expansion program 172 is executed to expand the compressed logo image data 173 onto the main memory 12 (Step S1-5), and the graphics controller 13 displays the logo image data 173 thus expanded (Step S1-6). Thus, a logo image is displayed, on the screen of the display device 3a, in a format which can be visually recognized by the user.

At this time, the expansion program 172 may be written to the main memory 12 while the logo image data 173 are expanded or the BIOS 171 may once copy the logo image data 173 in the compression state onto the main memory 12 and then expand the logo image data 173 over the main memory 12. Then, the BIOS 171 or the expansion program 172 converts the data written onto the main memory 12 into a proper format and writes the same data to the video memory 131.

The BIOS 171 or the expansion program 172 may directly expand and write the compressed logo image data 173 to the video memory 131 without carrying out the expansion of the logo image data 173 into the main memory 12.

By carrying out the processing, it is possible to execute the processing for expanding the compressed logo image data together with the processing for starting the computer 1. Therefore, a logo image to be displayed on the display device before the operation of the operating system can be caused to have a higher resolution.

Even when the BIOS and the expansion program and the like are stored in the BIOS-ROM having a limited capacity of, for example, 4 MB, and a capacity which can be allocated for the logo image data is approximately 100 KB, it is possible to store the compressed logo image data corresponding to 2 MB in a non-compression. Therefore, a logo image having a higher definition and a larger data volume and a photograph having a high resolution can be displayed on the display device before the operation of the operating system in the processing for starting the computer 1.

As described above, according to the embodiment of the invention, it is possible to provide an information processing apparatus in which a logo image to be displayed on a display device before an operation of an operating system can be caused to have a higher resolution.

The invention is not restricted to the embodiment but various changes can be made without departing from the scope.

What is claimed is:

1. An information processing apparatus configured to be operated with an operating system, comprising:
a display device;
a Basic Input/Output System (BIOS)-Read-only Memory (ROM) configured to store a BIOS program before starting the operating system;
a memory configured to store image data configured to be displayed on the display device during an execution of the BIOS program before starting the operating system;
a processor configured to execute a compression determination module configured to determine whether the image data in the memory is compressed and an expansion module configured to expand the compressed image data; and
a display controller configured to display the expanded image data on the display device.

2. An information processing apparatus configured to be operated with an operating system, comprising:
a display device;
a BIOS-ROM configured to store a BIOS program to be executed before starting the operating system;
a determination module configured to determine whether image data is compressed, the image data to be displayed on the display device during an execution of the BIOS program before starting the operating system;
an expansion module configured to expand the compressed image data; and
a display controller configured to display the expanded image data on the display device.

3. A method of controlling an information processing apparatus comprising a display device and configured to be operated with an operating system, the method comprising:
starting a BIOS program;
determining whether image data to be displayed on the display device in a memory is compressed during an execution of the BIOS program;
expanding the compressed image data;
displaying the expanded image data on the display device; and
starting the operating system.
